(19) United States
(12) Patent Application Publication
(10) Pub. No.: US 2006/0178602 A1
(43) Pub. Date: Aug. 10, 2006

(54) Vibratory penis ring

(76) Inventors: Wen-Chang Teng, Hsin Chuang City (TW); Kuo-Chou Yen, Hsin Chuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/052,947

(22) Filed: Feb. 9, 2005

(51) Int. Cl. A61H 19/00

(52) U.S. Cl. 601/70; 601/46; 600/38

(57) ABSTRACT

A vibratory penis ring mainly includes an outer and an inner ball made of a soft and elastic silicone material and having an uneven spherical outer surface, and a vibrating mechanism mounted inside the inner ball. When the vibrating mechanism is actuated, the inner ball is caused to continuously vibrate and roll inside the outer ball, so as to touch and lightly knock a user's penis through the outer ball to create a comfortable stimulating and massaging effect on the penis. The vibrating mechanism also includes light-emitting diodes to emit different color light for producing special sexual sensation.

### FIELD OF THE INVENTION

The present invention relates to a vibratory penis ring for putting around a user's penis or connecting to a condom, and more particularly to a vibratory penis ring including outer and inner balls made of a soft and elastic silicone material, and a vibrating mechanism mounted inside the inner ball. The vibrating mechanism brings the inner ball to continuously vibrate and roll inside the outer ball, so that a pleasant stimulating and massaging effect is created on a user's penis.

### BACKGROUND OF THE INVENTION

There are various types of vibratory penis rings available in the market. The penis ring is either connected to a condom or directly put around a penis, and is widely accepted among users because it not only protects a user from AIDS and other venereal diseases, but also increases the pleasure of sexual intercourse. FIG. 5 shows a conventional vibratory penis ring that includes a vibrating mechanism 200 having a hard shell. The hard shell is in direct contact with the sensitive skin of the user's penis, and tends to cause discomfort to the user and his mate when it is brought by the actuated vibrating mechanism 200 to compress and knock the user's penis.

It is therefore tried by the inventor to develop a novel vibratory penis ring to eliminate the drawbacks existed in the conventional products.

### SUMMARY OF THE INVENTION

A primary object of the present invention is to provide an improved vibratory penis ring that includes outer and inner balls made of a soft and elastic silicone material, and a vibrating mechanism mounted inside the inner ball. Since the vibrating mechanism is mounted inside the inner ball, and the inner ball is mounted inside the outer ball, there is not any hard shell on the vibratory penis ring to directly touch and/or knock the user's penis to cause any discomfort to the user. Moreover, the vibrating mechanism brings the inner ball to continuously vibrate and roll inside the outer ball, so that a pleasant stimulating and massaging effect is created on the user's penis.

Another object of the present invention is to provide an improved vibratory penis ring having a hollow outer ball made of a soft and elastic material, so that the elastic outer ball creates a massaging effect on the penis when it is compressed against the penis.

A further object of the present invention is to provide an improved vibratory penis ring having a hollow outer ball made of a soft and elastic material and provided over a spherical outer surface with strips or protruded patterns to produce unevenness on the outer ball, so that the vibratory penis ring creates enhanced sensationally stimulating and massaging effects on the user's penis when the outer ball is continuously compressed against the user's penis.

A still further object of the present invention is to provide an improved vibratory penis ring having a hollow inner ball, in which more than one light-emitting diode is mounted to emit different color light when a vibrating mechanism inside the inner ball is actuated to vibrate the penis ring.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a vibratory penis ring according to an embodiment of the present invention;

FIG. 2 is a sectional view of the vibratory penis ring of FIG. 1;

FIG. 3 is a first sectional view showing the operation of the vibratory penis ring of FIG. 1;

FIG. 4 is a second sectional view showing the operation of the vibratory penis ring of FIG. 1; and

FIG. 5 is a perspective view of a conventional vibratory penis ring.

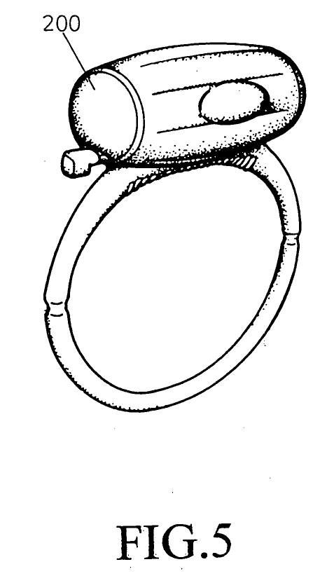

### DETAILED DESCRIPTION OF THE PREFERRED EMBODIMENTS

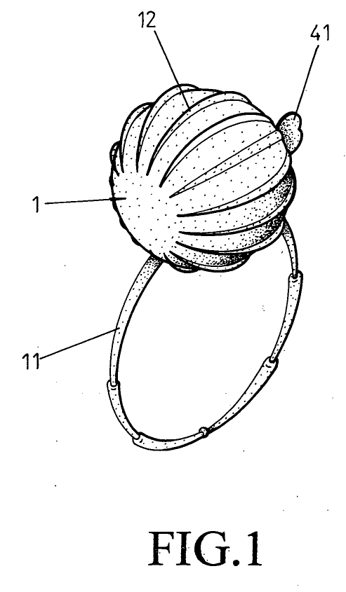

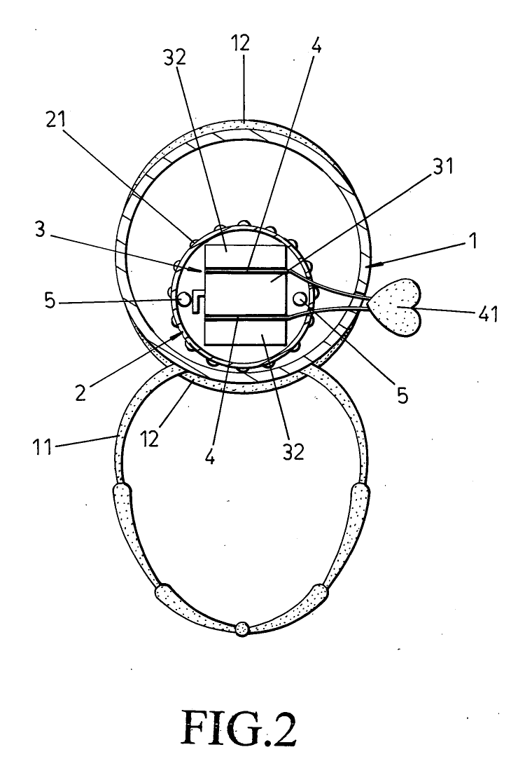

Please refer to FIGS. 1 and 2 that are perspective and sectional views, respectively, of a vibratory penis ring according to an embodiment of the present invention. As shown, the vibratory penis ring of the present invention mainly includes a hollow outer ball 1 made of a soft and elastic material, a hollow inner ball 2, and a vibrating mechanism 3.

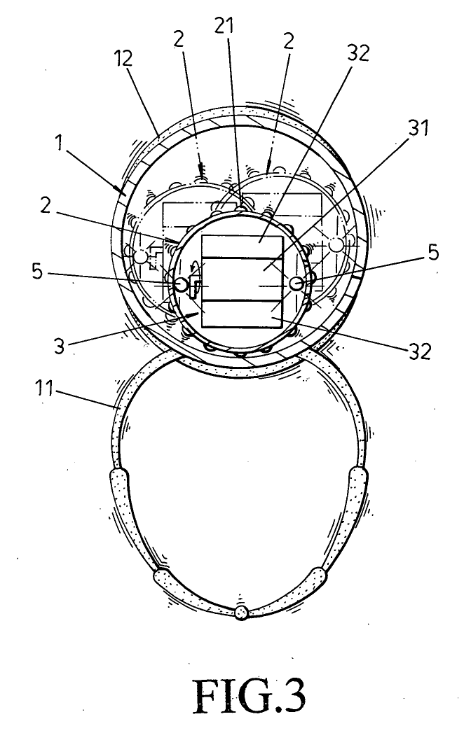

The outer ball 1 includes a ring portion 11 that is integrally molded with and projected from a spherical outer surface of the outer ball 1 for putting around a user's penis or connecting to a condom. The inner ball 2 is made of silicone material and is directly mounted inside the outer ball 1 in the process of manufacture. The vibrating mechanism 3 includes a motor 31 and batteries 32, and is mounted inside the inner ball 2. Before the first use of the vibratory penis ring, the batteries 32 are isolated from the motor 31 by an insulating sheath 4, a portion of which is exposed from the outer ball 1 to form a pull ring 41. To use the vibratory penis ring, the pull ring 41 is outward pulled to remove the whole insulating sheath 4 from the inner ball 2 and the outer ball 1, so that the motor 31 is in electrical contact with the batteries 32, as shown in FIG. 3. At this point, the inner ball 2 starts vibrating and rolling continuously inside the outer ball 1. The inner ball 2 is provided over a spherical outer surface with a plurality of protuberant dots 21. When the inner ball 2 vibrates and rolls inside the outer ball 1, the protuberant dots 21 continuously touch and lightly knock the penis from an inner side of the silicone-made outer ball 1 to produce a pleasant stimulating and massaging effect on the penis.

Please refer to FIGS. 2 and 3 at the same time. The vibrating mechanism 3 inside the inner ball 1 includes two light-emitting diodes (LED's) 5. When the insulating sheath 4 is pulled out of the outer ball 1 for the motor 31 to electrically connect to the batteries 32, the LED's 5 emit different color light that passes through the transparent or translucent inner and outer balls 2, 1 to create a special sensual stimulation.

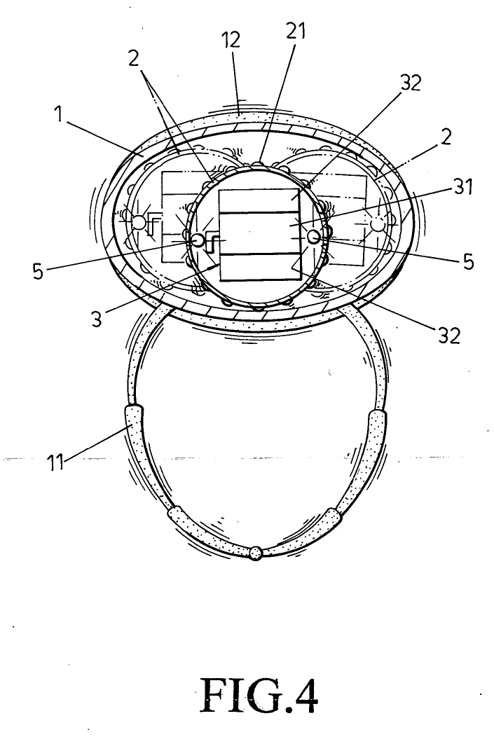

Please refer to FIG. 4. When the outer ball 1 is subjected to pressure and compressed, the vibrating mechanism 3 inside the inner ball 2 brings the inner ball 2 to vibrate and roll inside the outer ball 1.

Moreover, the outer ball 1 is provided over the spherical outer surface with a plurality of protruded strips 12, which forms unevenness on the outer ball 1 for the same to create enhanced massaging effect on the penis.

What is claimed is:

1. A vibratory penis ring, comprising:
an outer ball having a ring portion integrally projected from a spherical outer surface thereof;
an inner ball being mounted inside said outer ball and provided over a spherical outer surface with a plurality of protuberant dots;
a vibrating mechanism being mounted inside said inner ball and including a motor and batteries; and
an insulating sheath isolating said motor from said batteries and having an end exposed from said outer ball to form a pull ring, which could be pulled to remove said insulating sheath from said vibrating mechanism and said inner and outer balls for said motor to electrically contact with said batteries to produce vibration; and
said outer and said inner ball being made of a soft and elastic material without forming any rigid shell to uncomfortably touch a user's penis.

2. The vibratory penis ring as claimed in claim 1, wherein said vibrating mechanism further includes light-emitting diodes mounted inside said inner ball.

3. The vibratory penis ring as claimed in claim 1, wherein said outer ball is provided over said spherical outer surface with a plurality of protruded strips to form unevenness on said outer ball.
